(19) United States
(12) Patent Application Publication
(10) Pub. No.: US 2023/0167995 A1
(43) Pub. Date: Jun. 1, 2023

(54) DEVICES FOR USE IN AN INDOOR AIR QUALITY SYSTEM

(71) Applicant: Broan-NuTone LLC, Hartford, WI (US)

(72) Inventors: Richard R. Sinur, Hartford, WI (US); Kyle Anderson, Hartford, WI (US); Jeremy Yingst, Hartford, WI (US); Eric Theriault, Hartford, WI (US); Loic Ares, Hartford, WI (US); Jason Asmus, Hartford, WI (US); Seddik Rougab, Hartford, WI (US)

(21) Appl. No.: 17/745,938

(22) PCT Filed: Jan. 8, 2021
(86) PCT No.: PCT/US2021/012661

§ 371 Date: May 17, 2022

Related U.S. Application Data
(60) Provisional application No. 62/962,710, filed on Jan. 17, 2020.

(51) Int. Cl. F24F 11/58; F24F 11/64; F24F 11/00; G05B 19/042

(52) U.S. Cl. CPC F24F 11/58; F24F 11/64; F24F 11/0001; G05B 19/042; F24F 2110/65

(57) ABSTRACT

A system and method for obtaining environmental data—namely air quality information—from various devices contained within a structure is disclosed herein. The various devices contain sensors that can obtain environmental data, which is then analyzed by the system to determine if any level of a component within the data is outside of a predefined threshold range. If the system determines that the level of the component is outside of the predefined threshold range for that given component, the system will carry out certain steps in order to bring the level within the predetermined threshold range. These steps include selecting the appropriate appliance and the proper operating conditions to most efficiently bring the level back within the predetermined threshold range. Once the system has determined that the level is back within the predetermined threshold range, the system will instruct the selected appliance to turn OFF.

### CROSS-REFERENCE TO OTHER APPLICATIONS

The present application claims the benefit of PCT Application No. PCT/US21/12661, filed on Jan. 8, 2021, which claims the benefit of Provisional Application No. 62/962,710, filed on Jan. 17, 2020, which is incorporated in its entirety herein by reference and made a part hereof.

U.S. Provisional Application No. 62/789,501, filed on Jan. 7, 2019, PCT Patent Application No. PCT/US19/63581, filed on Nov. 27, 2019, U.S. patent application Ser. No. 16/243,056, filed on Jan. 8, 2019, U.S. patent application Ser. No. 16/242,498, filed on Jan. 8, 2019, U.S. patent application Ser. No. 15/081,488, filed on Mar. 25, 2016, U.S. patent application Ser. No. 14/593,883, filed on Jan. 9, 2015, U.S. Pat. No. 9,297,540, filed on Aug. 5, 2013, U.S. Pat. No. 10,054,127, filed on Sep. 29, 2017, U.S. Pat. No. 9,816,724, filed on Jan. 29, 2015, U.S. Pat. No. 9,816,699, filed on Sep. 2, 2015, U.S. Pat. No. 9,638,432, filed on Aug. 31, 2010, U.S. Pat. No. 8,100,746, filed on Jan. 4, 2006 and WO 2015/168243, filed on Nov. 5, 2015, all of which are incorporated in their entirety herein by reference and made a part hereof.

### TECHNICAL FIELD

The present disclosure relates to indoor air quality (“IAQ”) system, and particularly to a monitoring device for use within an IAQ system for use with an air venting systems. More particularly, the present disclosure relates to a monitoring device that is configured to monitor and regulate the air quality within a structure.

### BACKGROUND

Recently researchers have turned their attention to studying the negative effects that poor indoor air quality has on an individual's health because people spend close to 90% of their time indoors and about 65% of their time is in their home. Health conditions that appear to be negatively affected by poor indoor air quality include: (i) chronic obstructive pulmonary disease (COPD), asthmatics, heart disease, diabetes, obesity, neurodevelopmental disorders, among many others. Accordingly, a system that can not only monitor and raise awareness about the indoor air quality of a person's home, but can also improve indoor air quality is desirable.

Also, with the widespread adoption of smartphones and mobile devices for the implementation of smart home and Internet of things (IoT) functionality, users are provided with more opportunities to learn about and control their environment. Thus, the ability to control the indoor air quality of a user's home from a remote location is also desirable.

The description provided in the background section should not be assumed to be prior art merely because it is mentioned in or associated with the background section. The background section may include information that describes one or more aspects of the subject technology.

### SUMMARY

Described herein are monitoring devices for use within an IAQ system that is capable of obtaining environmental data—namely air quality information. In particular, these monitoring devices contain sensors that can obtain environmental data. This environmental data is then analyzed by the system to determine if any level of a component within the data is outside of a predefined threshold range. If the system determines that the level of the component is outside of the predefined threshold range for that given component, the system will carry out certain steps in order to bring the level within the predetermined threshold range. These steps include selecting the appropriate appliance and the proper operating conditions (e.g., turned ON/OFF and/or operating speed) of the selected appliance to most efficiently bring the level back within the predetermined threshold range. Once the system has determined that the level is back within the predetermined threshold range, the system will instruct the selected appliance to turn OFF.

It is understood that other configurations of the subject technology will become readily apparent to those skilled in the art from the following detailed description, wherein various configurations of the subject technology are shown and described by way of illustration. As will be realized, the subject technology is capable of other and different configurations, and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a structure that contains an IAQ system, which includes a plurality of monitoring devices;

FIG. 2 shows a basic block diagram of a monitoring device;

FIGS. 3A-3E show five different embodiments of a monitoring device that has a light switch configuration;

FIG. 4 is an exploded view of a first embodiment of the monitoring device of FIG. 3A;

FIG. 5 is a perspective view of the monitoring device of FIG. 4;

FIG. 6 is a zoomed-in view of the monitoring device of FIG. 5;

FIG. 7 is a partial cross-sectional view of the monitoring device of FIG. 5;

FIG. 8 is a perspective view of the monitoring device of FIG. 5 in a first unassembled state, wherein the buttons have been removed;

FIG. 9 is a perspective view of the monitoring device of FIG. 5 in a second unassembled state, wherein the buttons and top housing have been removed;

FIG. 10 is a perspective view of the monitoring device of FIG. 5 in a third unassembled state, wherein the buttons, top housing, and sensor board have been removed;

FIG. 11 is a frontal perspective view of the monitoring device of FIG. 5 in a fourth unassembled state, wherein the buttons, top housing, sensor board, and bottom housing have been removed;

FIG. 12 is a rear perspective view of the monitoring device of FIG. 5 in a fourth unassembled state, wherein the buttons, top housing, sensor board, and bottom housing have been removed;

FIG. 13 is a perspective view of the monitoring device of FIG. 5 in a fifth unassembled state, wherein the buttons, top housing, sensor board, bottom housing, and rear housing have been removed;

FIG. 14 is a perspective view of the monitoring device of FIG. 5 in a sixth unassembled state, wherein the buttons, top housing, sensor board, bottom housing, rear housing, and an extent of the wiring PCB have been removed;

FIG. 15 is a rear perspective view of the monitoring device of FIG. 5 in a seventh unassembled state, wherein the buttons, top housing, sensor board, bottom housing, rear housing, and extent of the wiring PCB, and top cover have been removed;

FIG. 16 is a frontal view of the monitoring device of FIG. 5 in a seventh unassembled state, wherein the buttons, top housing, sensor board, bottom housing, rear housing, and extent of the wiring PCB, and top cover have been removed;

FIG. 17 is a perspective view of the monitoring device of FIG. 5 in an eighth unassembled state, wherein the buttons, top housing, sensor board, bottom housing, rear housing, and extent of the wiring PCB, top cover, and power PCB have been removed;

FIG. 18 is a perspective view of the monitoring device of FIG. 5 in a ninth unassembled state, wherein the buttons, top housing, sensor board, bottom housing, rear housing, and extent of the wiring PCB, top cover, power PCB, and holder have been removed;

FIG. 19 is a cross-section of a second embodiment of the monitoring device of FIG. 3A;

FIG. 20 is a side view of the first and second embodiments of the monitoring device of FIG. 3A;

FIG. 21 is a side view of the first and second embodiments of the monitoring device of FIG. 3A, wherein dimensions of the frontal extent of the monitoring device are displayed;

FIG. 22a is a top view of the first and second embodiments of the monitoring device of FIG. 3A, wherein dimensions of the frontal extent of the monitoring device are displayed;

FIG. 22b is a front view of the first and second embodiments of the monitoring device of FIG. 3A, wherein dimensions of the frontal extent of the monitoring device are displayed;

FIG. 22c is a side view of the first and second embodiments of the monitoring device of FIG. 3A, wherein dimensions of the frontal extent of the monitoring device are displayed;

FIG. 23 is a circuit diagram of a single or sensor controlled bath fan;

FIG. 24 is a circuit diagram of a multi-speed or sensor controlled bath fan;

FIG. 25 is a circuit diagram of a single or multi-speed range hood;

FIG. 26 is a circuit diagram of an alliance electronic control;

FIG. 27 is a circuit diagram of a single or multi-speed product;

FIG. 28 is a circuit diagram of a single or variable speed product with a lighting element;

FIG. 29 is a circuit diagram of an alliance electronic control;

FIGS. 30a-30f show five different embodiments of a controller that has a plug configuration;

FIG. 31 is an exploded view of a sixth embodiment of a controller that has a plug configuration;

FIG. 32 is a perspective view of the sixth embodiment of controller of FIG. 31 in a fully assembled state;

FIG. 33 is a perspective view of the controller of FIG. 32 in a first unassembled state, wherein the faceplate has been removed;

FIG. 34 is a perspective view of the controller of FIG. 32 in a second unassembled state, wherein the faceplate, buttons, and lightguide have been removed;

FIG. 35 is a perspective view of the controller of FIG. 32 in a third unassembled state, wherein the faceplate, buttons, lightguide, and side cover have been removed;

FIG. 36 is a perspective view of the controller of FIG. 32 in a fourth unassembled state, wherein the faceplate, buttons, lightguide, side cover, and front cover have been removed;

FIG. 37 is a perspective view of the controller of FIG. 32 in a fifth unassembled state, wherein the faceplate, buttons, lightguide, side cover, front cover, and control PCB have been removed;

FIG. 38 is a perspective view of the controller of FIG. 32 in a sixth unassembled state, wherein the faceplate, buttons, lightguide, side cover, front cover, control PCB, and an extent of the inner holder have been removed;

FIG. 39 is a frontal perspective view of the controller of FIG. 32 in a seventh unassembled state, wherein the faceplate, buttons, lightguide, side cover, front cover, control PCB, and extent of the inner holder, and inner holder have been removed;

FIG. 40 is a first rear perspective view of the controller of FIG. 32 in a seventh unassembled state, wherein the faceplate, buttons, lightguide, side cover, front cover, control PCB, and extent of the inner holder, and inner holder have been removed;

FIG. 41 is a second rear perspective view of the controller of FIG. 32 in a seventh unassembled state, wherein the faceplate, buttons, lightguide, side cover, front cover, control PCB, and extent of the inner holder, and inner holder have been removed;

FIG. 42 is a perspective view of the controller of FIG. 32 in an eighth unassembled state, wherein the faceplate, buttons, lightguide, side cover, front cover, control PCB, and extent of the inner holder, inner holder, and back cover have been removed;

FIG. 43 is a first zoomed-in view of FIG. 42;

FIG. 44 is a second zoomed-in view of FIG. 38;

FIG. 45 is an exploded view of a seventh embodiment of a monitoring device that has a plug configuration;

FIG. 46 is a perspective view of the seventh embodiment of a monitoring device of FIG. 45 in a fully assembled state;

FIG. 47 is a perspective view of the monitoring device of FIG. 46 in a first unassembled state, wherein the buttons have been removed;

FIG. 48 is a perspective view of the monitoring device of FIG. 46 in a second unassembled state, wherein the buttons and faceplate have been removed;

FIG. 49 is a perspective view of the monitoring device of FIG. 46 in a third unassembled state, wherein the buttons, faceplate, and EVA pad have been removed;

FIG. 50 is a zoomed-in perspective to view the monitoring device of FIG. 46 in a fourth unassembled state, wherein the buttons, faceplate, EVA pad, and PM sensor have been removed;

FIG. 51 is a frontal perspective view of the monitoring device of FIG. 46 in a fourth unassembled state, wherein the buttons, faceplate, EVA pad, and PM sensor have been removed;

FIG. 52 is a perspective view of the monitoring device of FIG. 46 in a fifth unassembled state, wherein the buttons, faceplate, EVA pad, PM sensor, and sensor board have been removed;

FIG. 53 is a perspective view of the monitoring device of FIG. 46 in a sixth unassembled state, wherein the buttons, faceplate, EVA pad, PM sensor, sensor board, and frontal housing have been removed;

FIG. 54 is a first zoomed-in view of FIG. 53;

FIG. 55 is a second zoomed-in view of FIG. 53;

FIG. 56 is a third zoomed-in view of FIG. 53;

FIG. 57 is a fourth zoomed-in view of FIG. 53;

FIG. 58 is a first cross-sectional view of the monitoring device of FIG. 46;

FIG. 59 is a second cross-sectional view of the monitoring device of FIG. 46;

FIG. 60 is a third cross-sectional view of the monitoring device of FIG. 46;

FIG. 61 is a circuit diagram of a single output plug;

FIG. 62 is a circuit diagram of a dual output plug;

FIG. 63 is a first circuit diagram of a monitoring device;

FIG. 64 is a second circuit diagram of a monitoring device;

FIG. 65 is a third circuit diagram of a monitoring device;

FIG. 66 is a fourth circuit diagram of a monitoring device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Accordingly, the drawings, flow charts and detailed description are to be regarded as illustrative in nature, not restrictive or limiting.

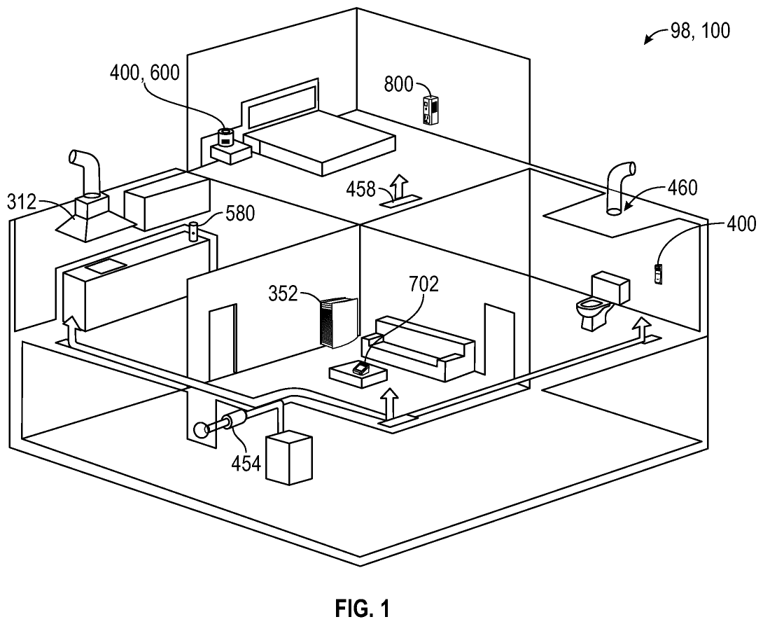

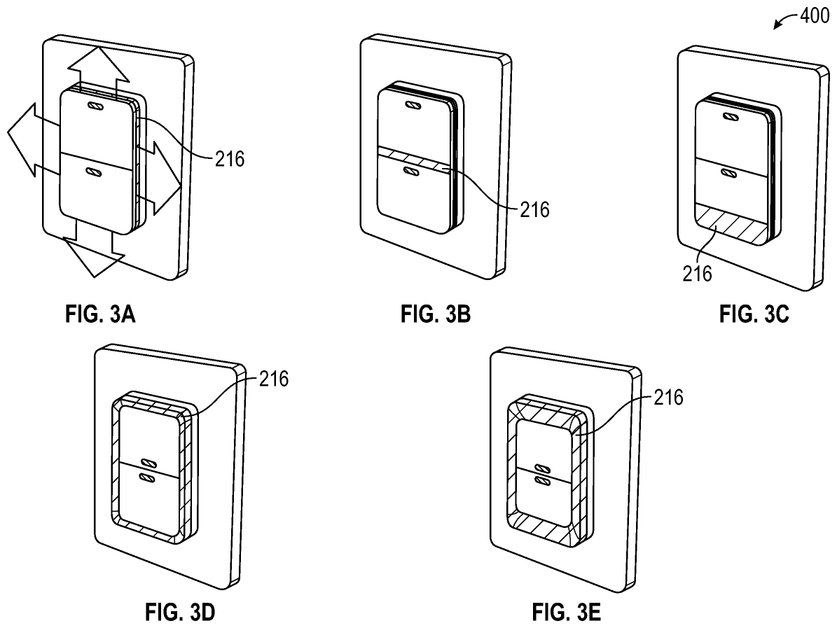

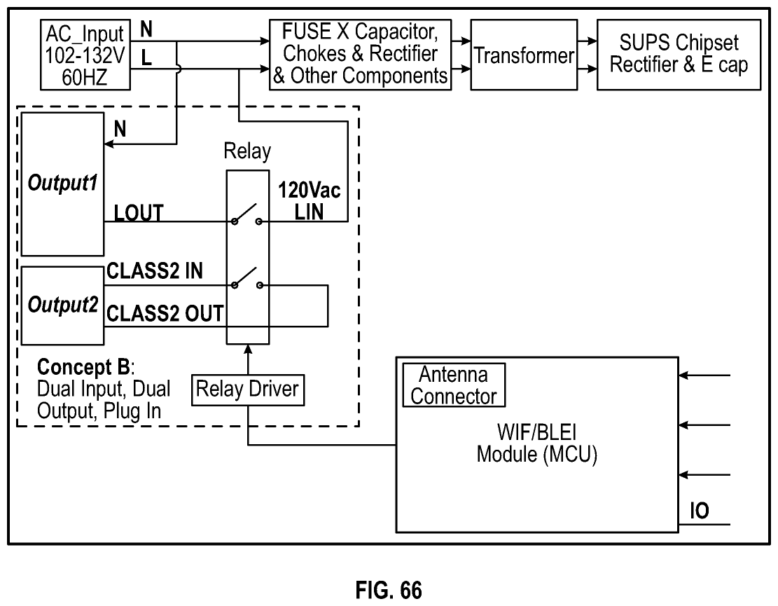

FIG. 1 of this application and FIGS. 1-82 of PCT/US20/12487 describe an IAQ system 10 that is capable of obtaining environmental data—namely air quality information, such as pollutant levels—from a monitoring device 102, a central unit 104, or a connected appliance 106, which are contained within an operating environment 98—namely a structure 100 (e.g., commercial building, a residential building, a single-family home, an apartment, etc.). These devices 102, 104, and 106 are configured to record environmental data, which includes various components (e.g., temperature, humidity and/or pollutant levels, such as TVOC, CO₂, PM2.5), and send the recorded levels of the components of the environmental data to a local server/database 110. FIGS. 3A-66 of this application discloses additional details about the design, structure, functionality and positional relationships of structures within each of the monitoring devices 102.

After the record environmental data has been recorded, the local server/database 110 may: i) analyze the data, ii) determine if all levels contained within environmental data are within predefined threshold ranges, and iii) may recommend that the IAQ system 10 take certain steps (e.g., turn ON/OFF various appliances) to bring certain levels of the components within the predetermined threshold range. The IAQ system 10 can then carry out these steps by controlling the operational mode (e.g., ON/OFF and/or the speed of the fan) of various appliances 106 contained within the operating environment 98. Once the IAQ system 10 has determined that the levels contained within the environmental data are back within the predetermined threshold ranges, the IAQ system 10 will instruct the appliances 106 to turn OFF.

1) Exemplary Operating Environment

FIG. 1 is a partial cut-away view of an operating environment 98, which contains one of the exemplary IAQ system 10. Specifically, this exemplary IAQ system 10 includes: (i) in-wall monitoring device 400, (ii) plug-in monitoring device 800, (iii) potable monitoring device 580, (iv) central unit 702, (v) connected range hood 312, (vi) connected air ionizer 352, (vii) non-connected humidifier 406 that is coupled to a controller 600, (viii) non-connected supply fan 454, and (ix) non-connected bathroom fan 460. It should be understood that this is only exemplary and other configurations of the operating environments 98 are contemplated by this disclosure.

2) Block Diagram of the Monitoring Device

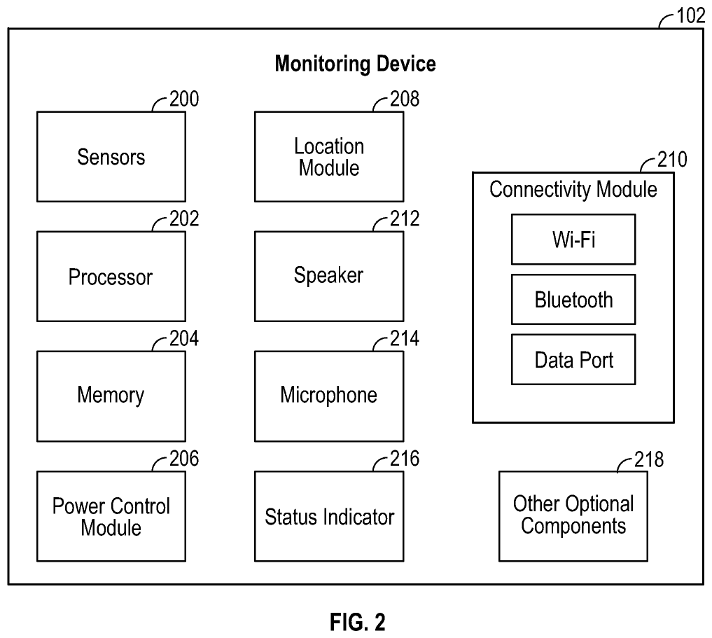

FIGS. 2 and 3A of PCT/US20/12487 illustrates a block diagram of an exemplary monitoring device 102 of the IAQ system 10. Specifically, the monitoring devices 102 may include the following elements: i) sensors 200, ii) processor 202, iii) memory 204, iv) power control module 206, v) location module 208, and vi) connectivity module 210. In some embodiments, the monitoring devices 102 may include other optional components, which include: i) speaker 212, ii) microphone 214, iii) status indicator 216, or iv) other optional components (e.g., components that can control the operational setting of the device, data inputs, or lights) 218. Meanwhile, the central unit 104 may be any internet enabled device (e.g., computer, laptop, mobile device, cellular phone, etc.) that includes displaying the current and/or historical data collected by the IAQ system 10. In alternative embodiments, the central unit 104 may contain all of the same components and features of the monitoring devices 102 along with a display 220 for displaying the current and/or historical data collected by the IAQ system 10.

a) Sensor(s)

The sensor(s) 200 that are contained within the monitoring device 102 are configured to collect data about the local environment 98. The sensor(s) 200 may include any one of, or any combination of, the following: (i) air pollutant sensor, (ii) humidity/temperature sensor, (iii) motion sensor, (iv) light/color sensor, (v) camera, (vi) passive infrared (PIR) sensors or (vii) other sensors (e.g., infrared, ultrasonic, microwave, magnetic field sensors). It should be understood that the term environmental data is comprised of measurements taken from these sensors and these measurements are referred to herein as levels of components. In particular, the air pollutant sensor is configured to detect a concentration of one or more air pollutants in the environment within the structure 100, including: CO, CO₂, NO, NO2, NOX, PM2.5, ultrafine particles, smoke (PM2.5 and PM10), radon, molds and allergens (PM10), volatile organic compounds (VOCs), ozone, dust particulates, lead particles, acrolein, biological pollutants (e.g., bacteria, viruses, animal dander and cat saliva, mites, cockroaches, pollen and etc.), pesticides, and formaldehyde. The humidity/temperature sensor measures the temperature and/or humidity in the environment within the structure 100 to establish an ambient baseline and to detect changes in the conditions of the environment within the structure 100. The motion sensor, light/color sensors, camera, and other sensors may be used to monitor habits of humans or animals near the monitoring device 102 to establish a baseline trend and to detect changes in the baseline. Changes in this baseline trend may be helpful in determining why changes occurred within the recorded environment data. Alternatively, this baseline may be used by the IAQ system 10 to suggest different or alternative steps to maximize the air quality within the structure 100.

b) Memory

The memory 204 may be utilized to temporarily store the environmental data before this data is sent to the local server/database 110. Typically, the predetermined threshold range(s) or value(s) may be programmed within the memory contained in the local server/database 110 or the central unit 104. However, in some embodiments, some or all of the predetermined threshold range(s) or value(s) may be programmed within the memory 204 of the monitoring devices 102. Regardless of where these predetermined threshold ranges (s) are stored, the range(s) or value(s) may be preprogrammed into the IAQ system 10. Specifically, there preprogrammed range(s) or value(s) may be determined by the system designer based on one or more of the following: regulatory bodies, government agencies, private groups or standard setting bodies, such as the ASHRAE Standard Committee (e.g., ANSI/ASHRAE 62.2-2016, ISSN 1041-2336, which is fully incorporated herein by reference). An example of the range(s) that may be preprogrammed into the system 10 is shown in the below table, where the system 10 will send the alert or take start to take corrective action when the air quality reaches the “Fair” reference level. It should be understood that the if the air quality reaches the “Poor” reference level or the “Bad” reference level, the system 10 may take additional actions or more aggressive action in order to try and return the air quality within the structure 100 to at least a “Good” reference level within a reasonable amount of time. It should further be understood that these range(s) are only exemplary and should not be construed as limiting.

| Reference | IAQ | CO₂ | TVOC | PM2.5 | |
|---|---|---|---|---|---|
| Level | Rating | (ppm)* | (μg/m³)* | (μg/m₃)* | RH %* |
| Excellent | 0-20 | ≤600 | <300 | <25 | 40-60 |
| Good | 21-40 | 601-1000 | 301-1000 | 25-40 | <40/>60 |
| Fair | 41-60 | 1001-1500 | 1001-3000 | 40-150 | <30/>70 |
| Poor | 61-80 | 1501-2000 | 3001-10000 | 150-250 | <20/>80 |
| Bad | 81-100 | >2000 | >10000 | >250 | <10/>90 |

It should be understood that predetermined threshold range(s) or value(s) may be updated by replacing the levels within the local server/database 110 or by using over the air updates in order to update levels that are stored in memory 204 of the monitoring devices 102.

Instead of preprogramming the predetermined threshold range(s) or value(s) into the IAQ system 10, the range(s) or value(s) may be determined/modified by calibrating the IAQ system 10 to the structure 100. In order to provide these range(s) or value(s), the following steps may be undertaken. First, the monitoring unit 102 collects data from the sensors 200 over a predefined time period (e.g., 1 day, 3 days, or 7 days). This environmental data is then compared against recommended levels that are set forth by various regulatory bodies, government agencies, private groups, or standard setting bodies. Based on this comparison, the IAQ system 10 determines the threshold range(s) or value(s). For example, if the measured level of the components is more than one standard deviation below or above the recommended levels, then the system 10 may adjust recommend levels down or up that standard deviation. Performing these steps helps ensure that the IAQ system 10 is calibrated to the specific structure 100, while being within recommended levels that are provided by the groups. This reduces false alarms and too many alarms, which allows the system 10 to run more efficiently. For example, if the environmental data from the structure 100 suggests that all levels of the components are well within the recommended levels, then set the thresholds at the recommended levels would not provide any useful information and the IAQ system 10 would rarely turn ON, if at all. On the other hand, if the environmental data from the structure 100 suggests that all levels of the components are not within the recommended levels, then set the thresholds based only on the data from the structure 100 would not be very helpful to aid the user in correcting their air quality. Thus, the IAQ system 10 utilizes both the environmental data collected from the structure along with the recommended levels data to provide the most accurate threshold ranges.

In a further alternative, the predetermined threshold range(s) or value(s) may be based on data collected over a predefined amount of time by systems 10 that have been deployed across the country. The collected data can then be analyzed in connection with the recommended levels, which are set forth by various regulatory bodies, government agencies, private groups, or standard setting bodies. Based on this comparison, the system 10 may adjust the predetermined threshold range(s) or value(s). It should be understood that the predetermined threshold range(s) or value(s) may differ on a region, state, city, or neighborhood basis. For example, the analysis of the collected data and the threshold range(s) may suggest that an IAQ system 10 that is located within Downtown, Los Angeles should have different range(s) then system 10 that are installed in: (i) Malibu, California, (ii) Tahoe, California, Oregon, or (iv) within the northwestern part of the U.S. Based on this analysis, the system 10 can adjust the range(s) or value(s) to account for these differences. In other words, the system 10 may have one set of range(s) or value(s) for a system 10 located within Downtown, Los Angeles and another set of range(s) or value(s) for a system 10 located within Portland, Oreg. In an even further alternative, the predetermined threshold range(s) or value(s) may be set or modified by the user.

c) Power Control Module

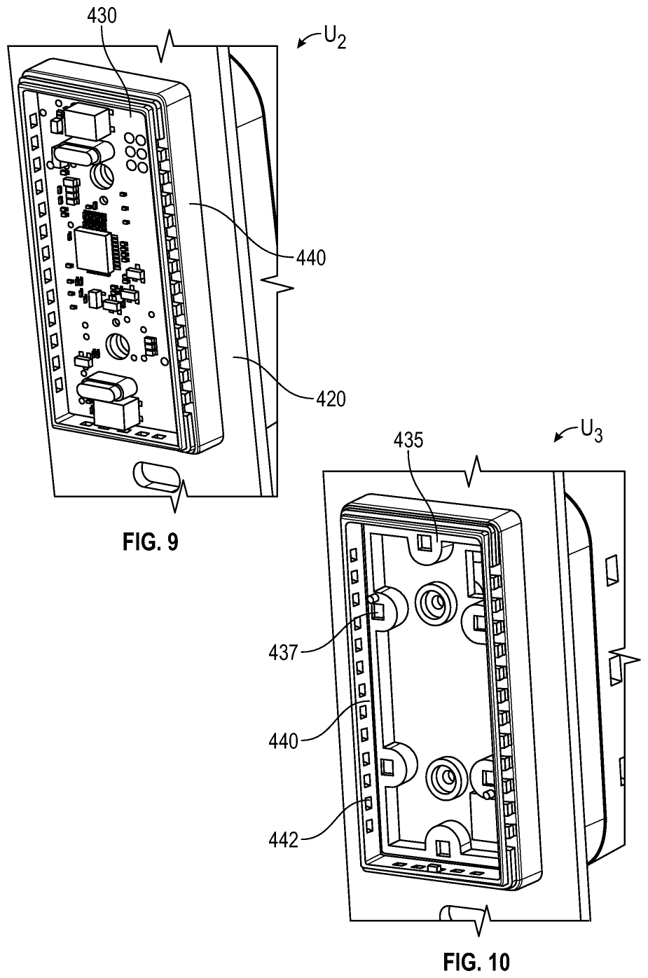

The monitoring devices 102 include a power control module 206, which controls the power of the monitoring devices 102 and any non-connected appliance 400 that is connected to the monitoring devices 102. This module 206 allows the user and/or IAQ system 10 to turn ON/OFF the power supplied to an appliance 106, which is connected to the monitoring devices 102. In other words, this module 206 allows the IAQ system 10 to control non-connected appliances 400 using the monitoring devices 102. Examples of non-connected appliances are shown in FIGS. 9, 10A and 10B.

d) Location Module

The monitoring device 102 includes a location module 208 that aids the IAQ system 10 in determining the location of the monitoring device 102 within the structure 100 and what appliances 106 are positioned near or adjacent to the monitoring device 102. This locational information aids the IAQ system 10 in determining the steps necessary to return a level contained within the environmental data back to the predetermined threshold range. The location module 208 is configured to determine the location of the monitoring devices 102: (i) based on the information entered by the authorized user, (ii) using an indoor positioning system, (iii) using an absolute locating system, or (iv) a hybrid system. In the first embodiment, the location module 208 may determine the location of the monitoring device 102 and the appliances 106 are positioned nearby based on inputs from the user. Specifically, the IAQ system 10 may utilize an application that is installed on an Internet enabled device to provide the user with a number of questions about the structure 100. For example, the application may ask generic questions about the structure 100, which may include: i) number of bedrooms/bathrooms, ii) square footage of the structure, iii) which bathrooms are connected to bedrooms, iv) closest bathroom to the kitchen, v) how many levels does the structure have, vi) rough room dimensions, vii) other questions geared to determining the rough layout of the structure 100, and viii) other similar questions. Next, the application may ask the user about the location of the devices within the structure 100. For example, the application may ask generic questions about the location of the monitoring devices 102 and appliances 106, which may include: i) is the monitoring device 102 located within the master bedroom or kitchen. Next, the application may ask the user for information about the appliances 106. For example, the application may ask the user the CFM rating of the bathroom fan or the range hood. Once all of this information is inputted into the application by the user, the IAQ system 10 may ask the user which appliance 106 should be turned on when a specific monitoring device 106 measures a level that is outside of a predetermined threshold range.

In an alternative embodiment, the locating module 208 may utilized indoor positioning sensors that are built into each appliance 106 or maybe temporally attached to appliances 106. For example, upon purchasing the IAQ system 10, the user may be provided with a number of indoor positioning sensors that can be temporally attached to non-connected appliances 400. Specifically, indoor positioning sensors may utilize one or a combination of the following technologies: i) magnetic positioning, ii) GPS along with dead reckoning, iii) positioning using visual markers (e.g., use of the camera that is built into the monitoring unit 102), iv) visible light communication devices, v) infrared systems, vi) wireless technologies (e.g., Wi-Fi positioning system, Bluetooth Low Energy (“BLE”), iBeacon, other beacon technology, received signal strength, ultra wide-band technologies, RFID), or vii) other methods discussed in the papers that were attached to U.S. Provisional Application No. 62/789,501. The user then may be instructed to attach these sensors to these non-connected appliances 400. Once these sensors are in place and the connected devices and monitoring devices 104 are turned on, the IAQ system 10 can determine which devices are closest to each monitoring device 102 along with the relative positioning of the monitoring devices 104 to one another. Based on this relative location, the IAQ system 10 can then ask the user for additional information about the functionality of each device and additional information about the room layouts. Once this information is entered into the IAQ system 10, the IAQ system 10 will be able to determine the steps necessary to return a level contained within the environmental data back to the predetermined threshold range.

In a further alternative embodiment, the locating module 208 may utilize sensors that can provide the absolute location of each monitoring unit 102 and appliance 106 within the structure 100. The absolute location system may require a user to upload a map of the structure 100 to the local server/database 110. This map of the structure 100 may be generated based on: i) blueprints of the structure 100 or ii) determined by a device that is capable of mapping the structure 100 after the structure 100 was built. Such devices include software programs that can be loaded on a cellular phone or a robotic vacuum. In a particular example, the user may utilize a robotic vacuum to map the structure 100. Once the structure 100 is mapped, the robotic vacuum can upload the map to the local server/database 110. The IAQ system 10 can then place the monitoring devices 102 and the appliances 106 within the structure 100 based on the readings from indoor positioning systems. Once the IAQ system 10 has placed the monitoring devices 102 and the appliances 106 within the structure 100, the user can then login to the local server/database 110 using an internet enabled device and can confirm their position. In an even further embodiment, the locating module 208 may use any combination of the methods described above. For example, the IAQ system 10 may ask the user a number of questions and then use the indoor positioning system in the above described embodiments.

e) Connectivity Module

The connectivity module 210 is a module that enables the monitoring unit 102 to send data to another device, such as the local server/database 110 or the central unit 104. The connectivity module 210 may use any one, or combination, of the following wireless or wired technologies/communication protocols: Bluetooth (e.g., Bluetooth version 5), ZigBee, Wi-Fi (e.g., 802.11a, b, g, n), Wi-Fi Max (e.g., 802.16e), Digital Enhanced Cordless Telecommunications (DECT), cellular communication technologies (e.g., CDMA-1X, UMTS/HSDPA, GSM/GPRS, TDMA/EDGE, EV/DO, or LTE), near field communication (NFC), Ethernet (e.g., 802.3) FireWire, BLE, ZigBee, Z-Wave, 6LoWPAN, Thread, WIFI-ah, RFID, SigFox, LoRaWAN, Ingenu, Weightless, ANT, DigiMesh, MiWi, Dash7, WirelessHART, advanced message queuing, data distribution service, message queue telemetry transport, IFTTT, inter-integrated circuit, serial peripheral interface bus, RS-232, RS485, universal asynchronous receiver transmitter, USB, powerline network protocols, a custom designed wired or wireless communication technology, or any type of technologies/communication protocol listed within the papers that were attached to U.S. Provisional Application No. 62/789,501.

Using any one of the above technologies/communication protocols, the environment data that is collected by the monitoring unit 102 may be sent to a device outside of the monitoring unit 102 in at least three different ways. The first way is where the monitoring device 102 will only send the environment data at a predefined time interval. This predefined time interval (e.g., 30 seconds, 1 minute, 3 minutes, 5 minutes, 10 minutes, 30 minutes, every hour, every 24 hours, or anytime therebetween) may be preprogrammed into the IAQ system 10 or may be set by the user. It should be understood that in this method, the monitoring device 102 does not perform any calculations and instead raw sensor data is simply sent from the monitoring device 102 to the central unit 104 or the local server/database 110 for processing. This method is beneficial because it does not require that the monitoring device 102 perform calculations to determine if a level within the environmental data that is outside of the predefined threshold ranges. However, more data may be transmitted outside of the monitoring device 102 and there may be a lag between when an alert event occurs and when the IAQ system 10 detects the alert event.

A second way of sending environment data to a device that is outside of the monitoring device 102 is where the monitoring device 102 sends data only when an alert event occurs. In this method, the monitoring device 102 must have capabilities sufficient to process the raw data collected by the sensor 200 in order to determine if a level that is within the environmental data is outside of the predefined threshold range(s) or value(s). Upon making a determination that a level within the environmental data that is outside of the predefined threshold ranges, the monitoring device 102 sends this alert data to the central unit 104 or the local server/database 110 for the IAQ system 10 to perform the next steps. This method is beneficial because it requires the least amount of data to be sent from the monitoring device 102 to another device.

The third way of sending environment data to a device that is outside of the monitoring device 102 is a hybrid of the first and second methods. Specifically, the monitoring device 102: i) sends the environment data at predefined intervals (e.g., 5 minutes, 10 minutes, 30 minutes, every hour, every 24 hours, or anytime therebetween) and ii) sends the environment data when a sensor alert occurs. The hybrid approach requires that the monitoring device 102 send the extra data that is required by the first way and have the additional processing power that is required by the second way. Nevertheless, this hybrid approach avoids the lag time that is described in the first way and allows the user to view historical environmental data that is below the alert level.

f) Other Module(s)

The monitoring devices 102 may include a microphone 214 and other electronic components 218 necessary to allow for voice control of the monitoring devices 102. In addition, the microphone 214 and other electronic components 218 can be used to allow the monitoring device 102 to be controlled or operate with any virtual assistant (e.g., Amazon Alexa, Microsoft Cortana, Google Assistant, Samsung Bixby, Apple Siri, or any other similar virtual assistant). The monitoring devices 102 may also include a status indicator 216, which provides a general indication of the indoor air quality at or near the monitoring devices 102. For example, the monitoring devices 102 may show a red light if the air quality is bad, a green light if the air quality if good, and a yellow light if the air quality is between bad and good.

3) Exemplary Monitoring Devices

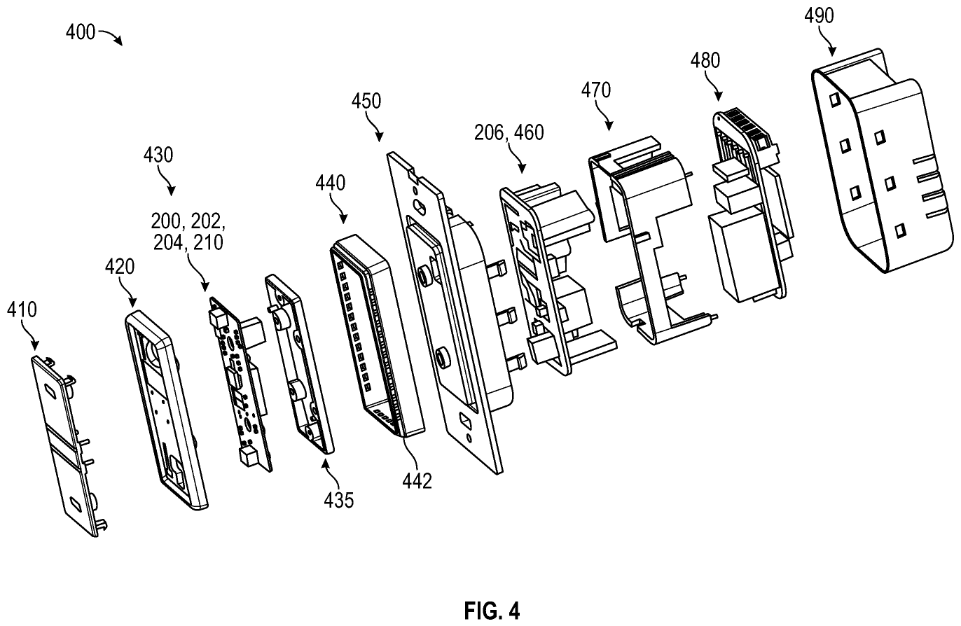

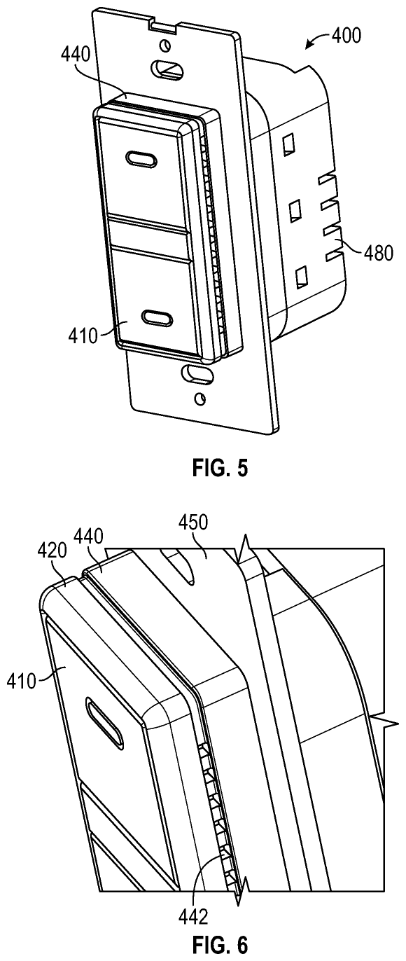

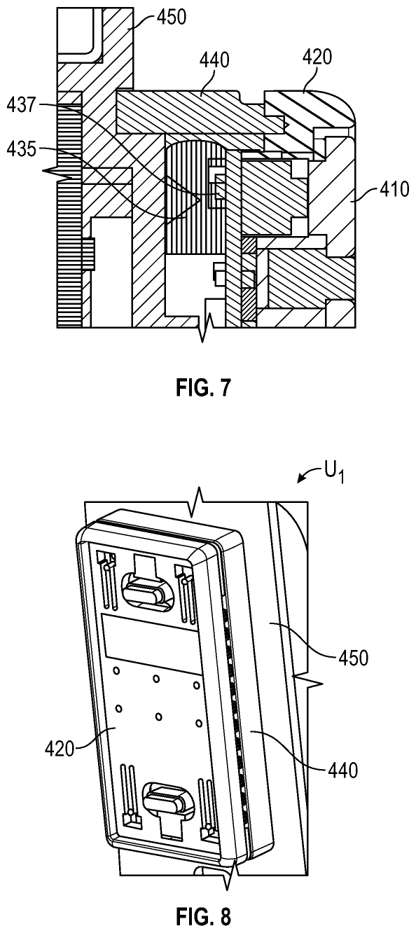

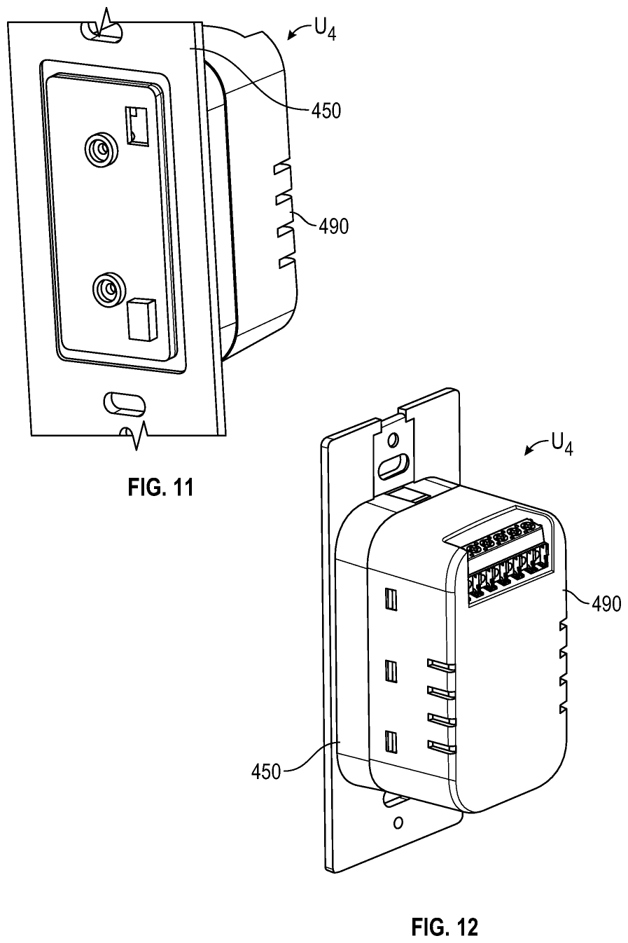

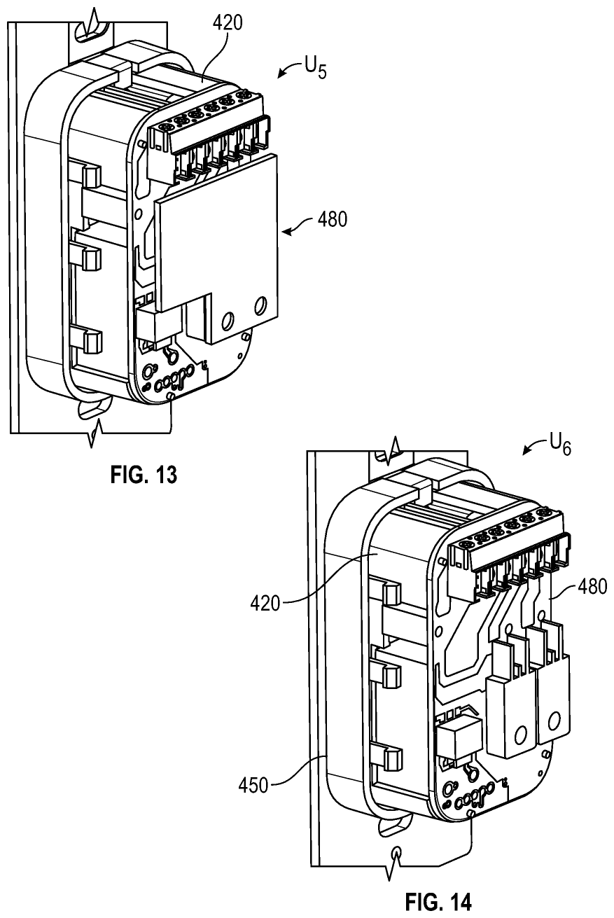

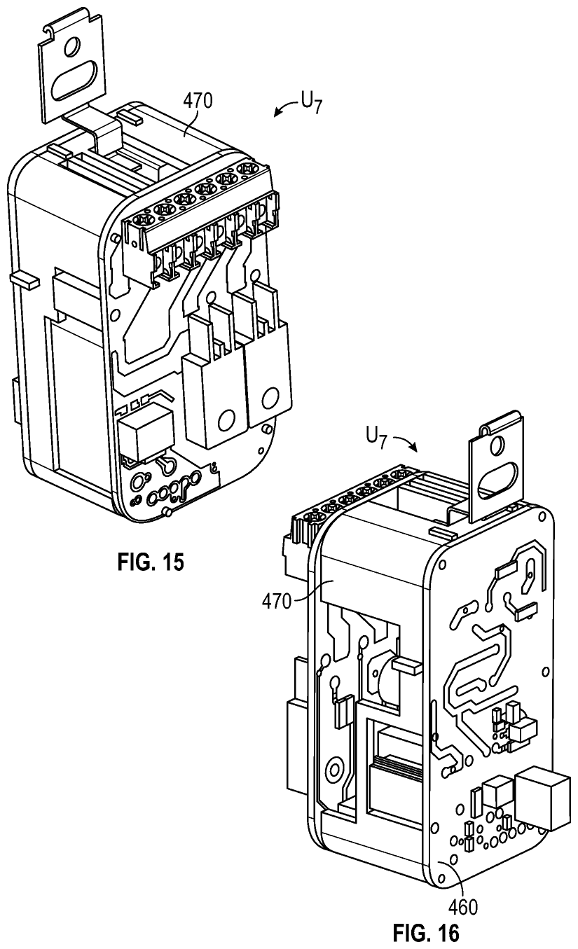

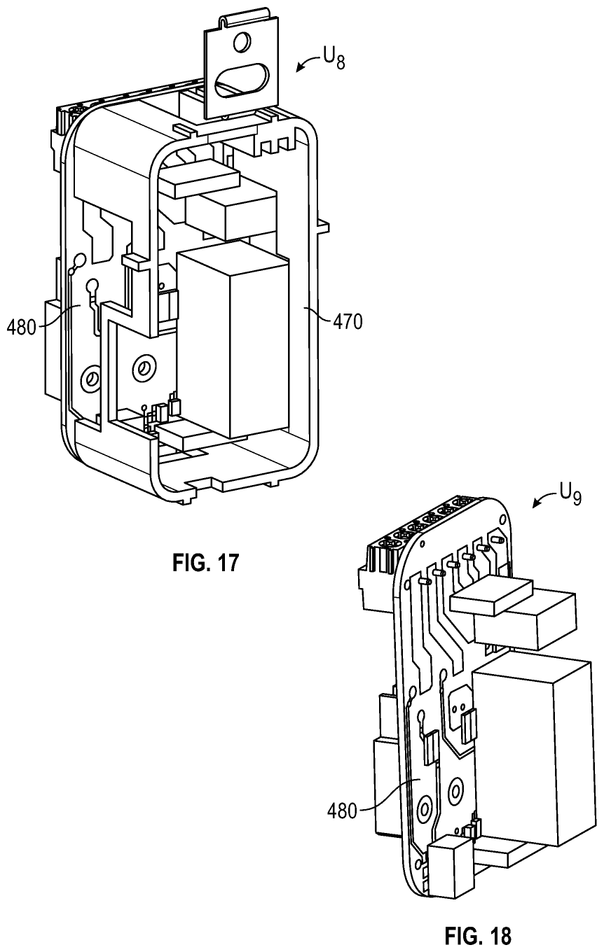

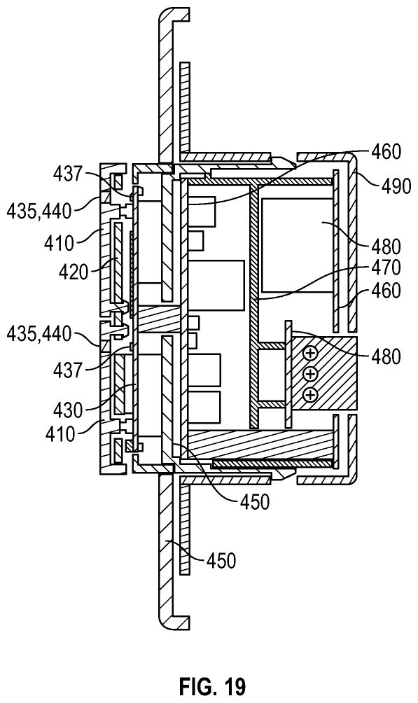

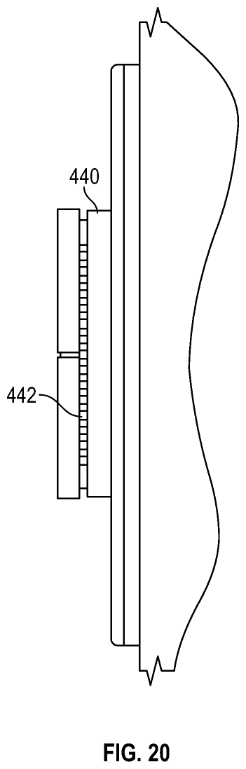

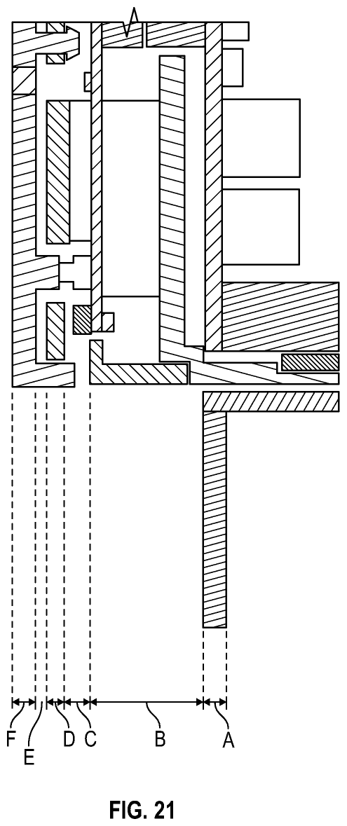

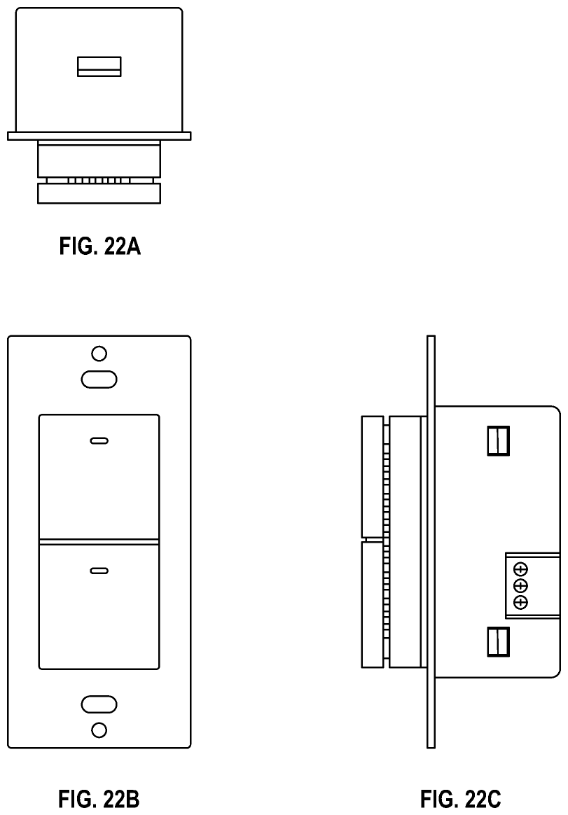

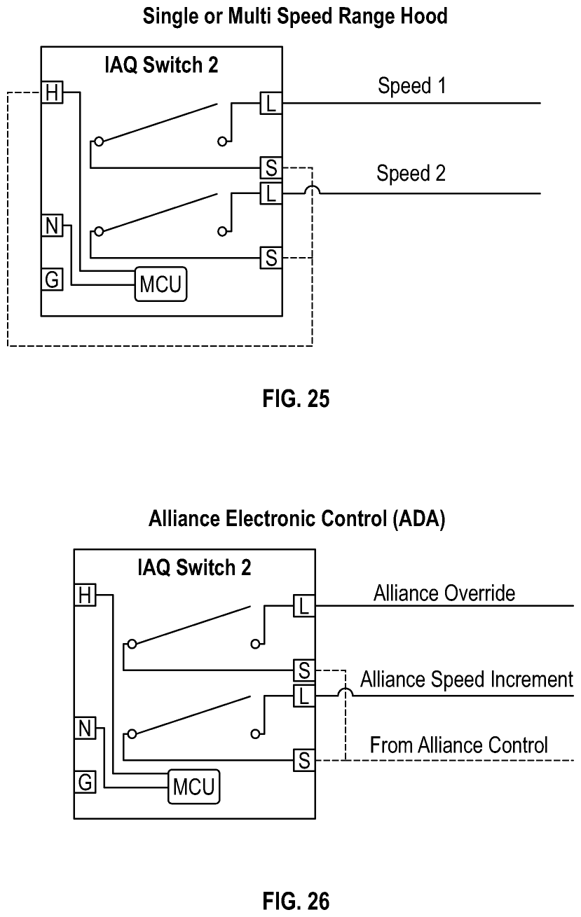

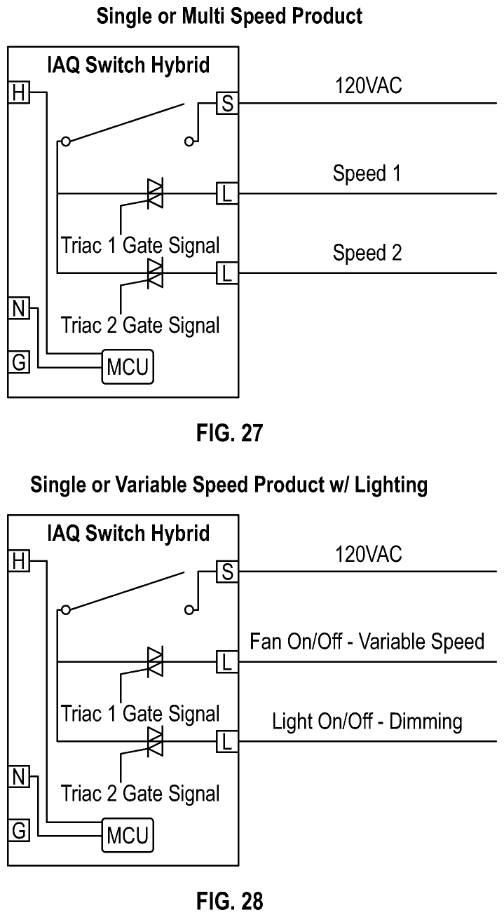

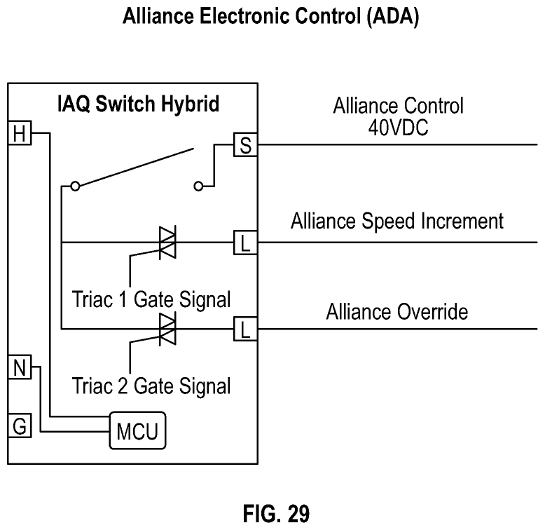

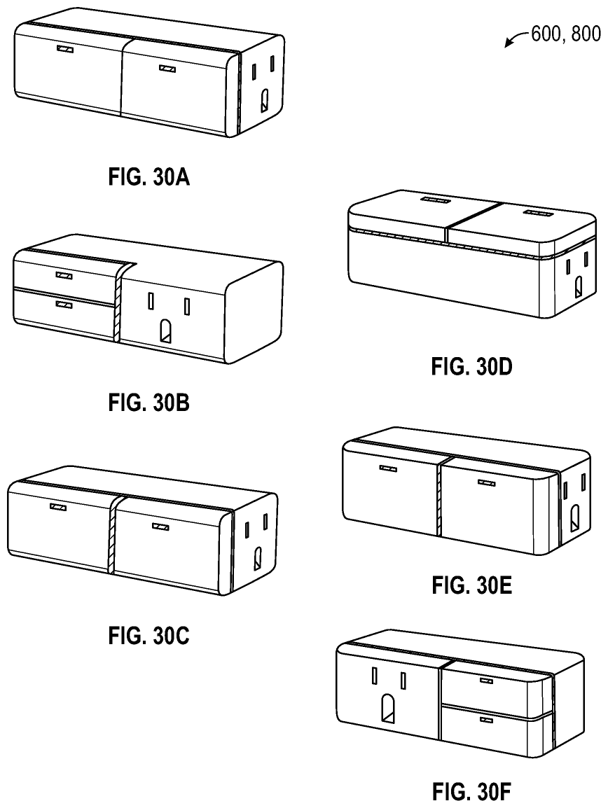

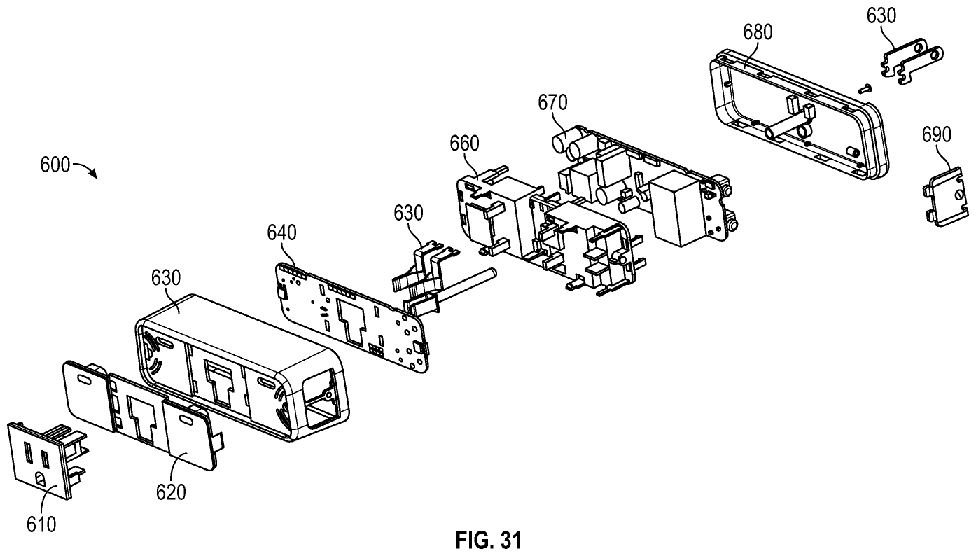

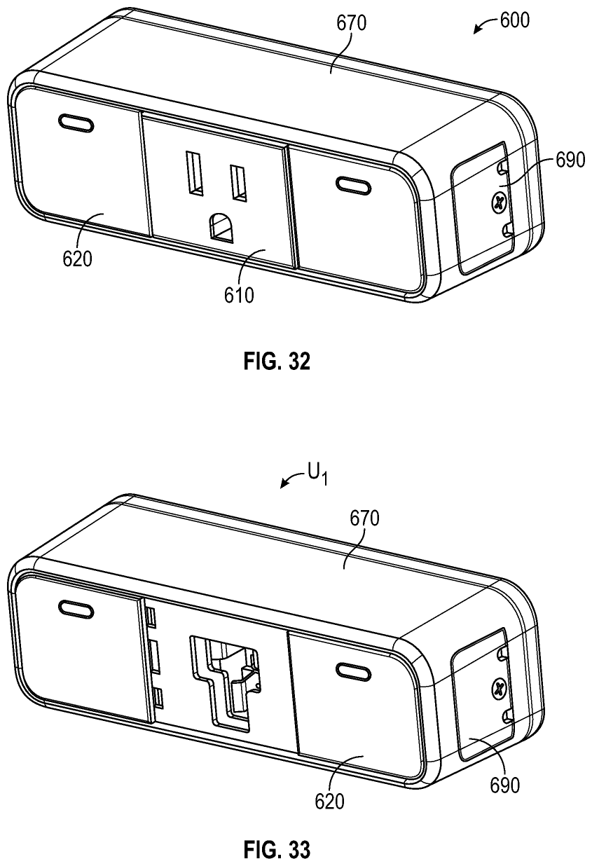

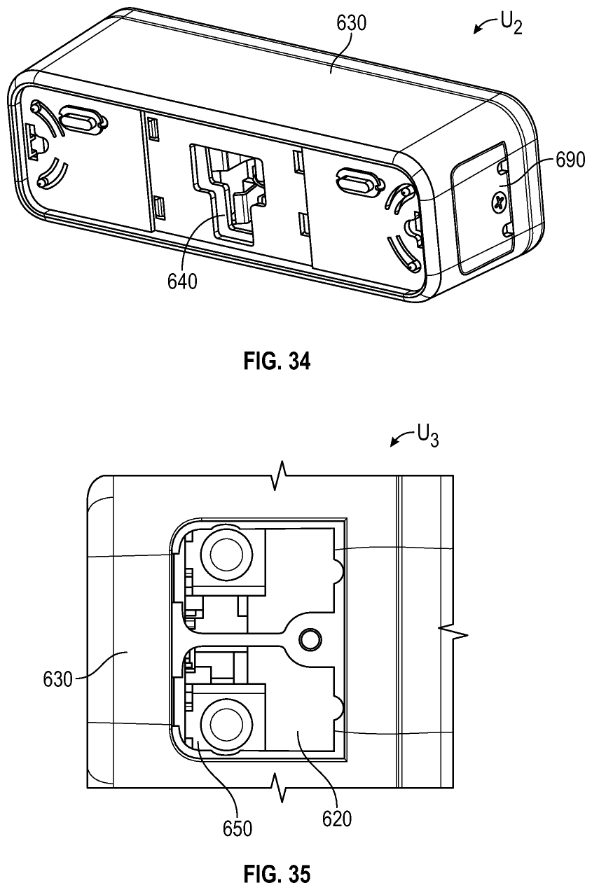

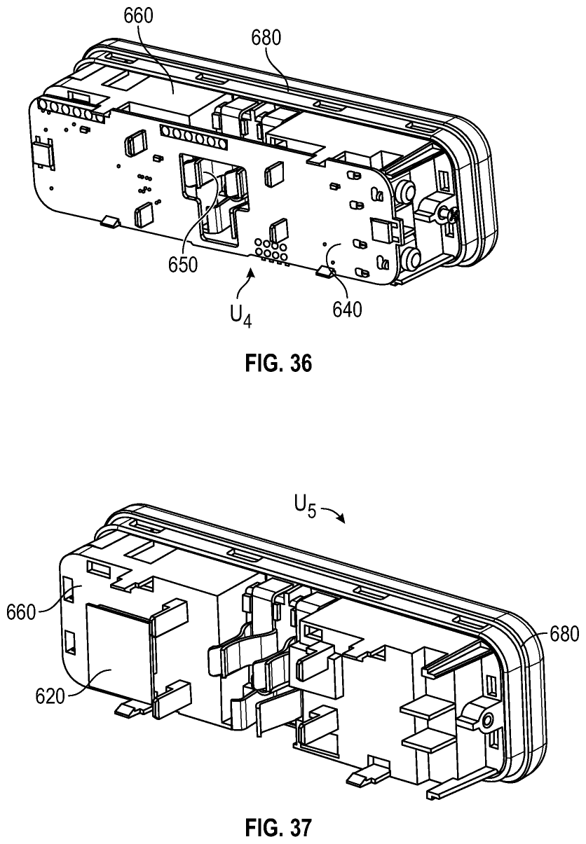

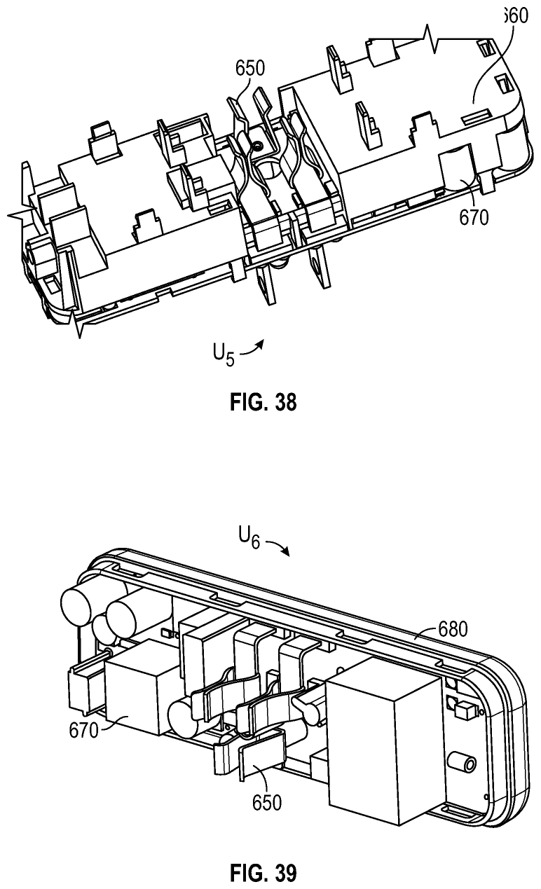

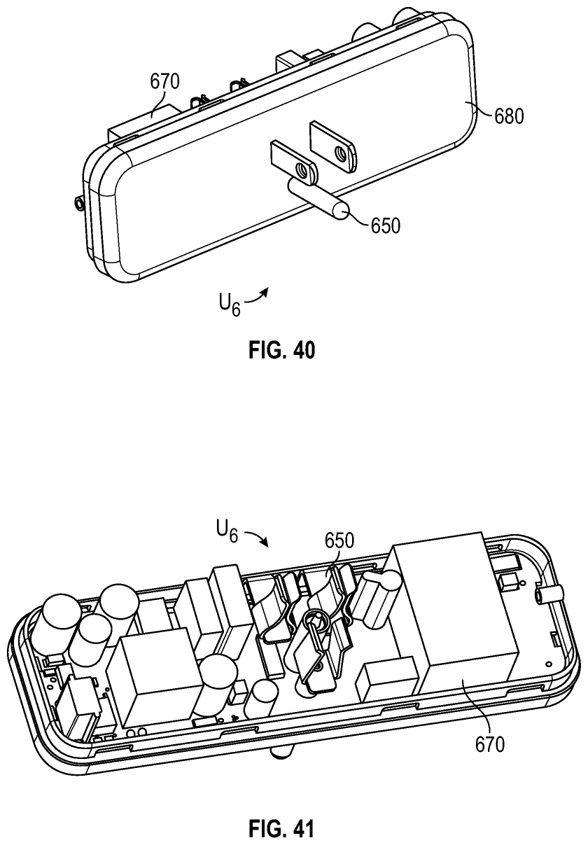

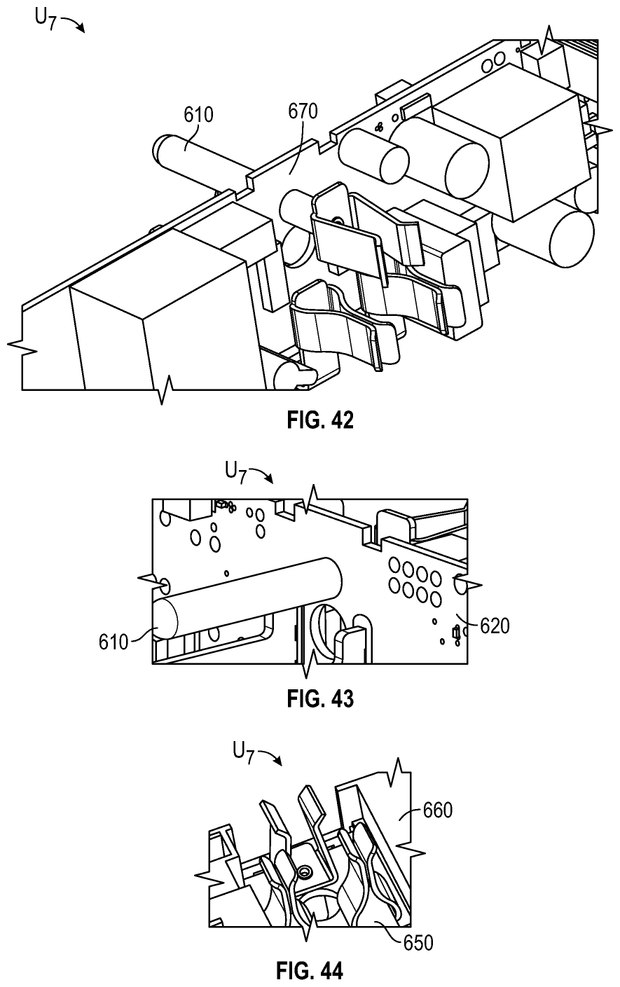

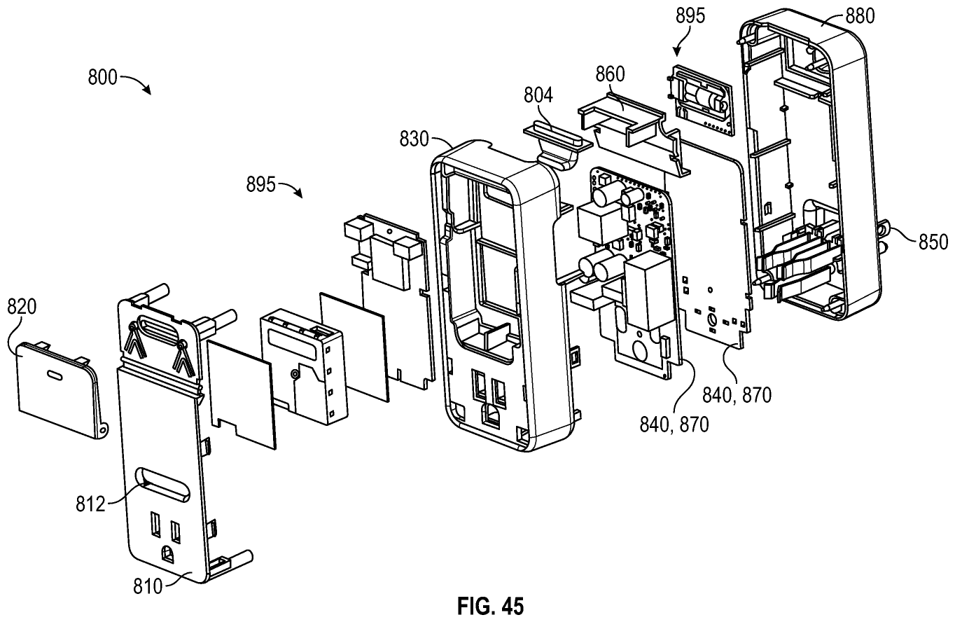

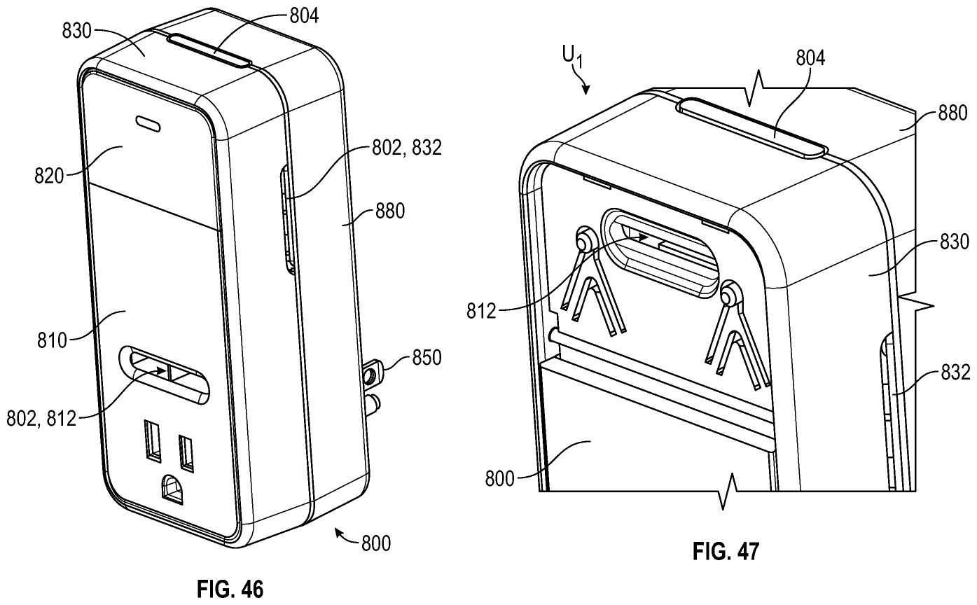

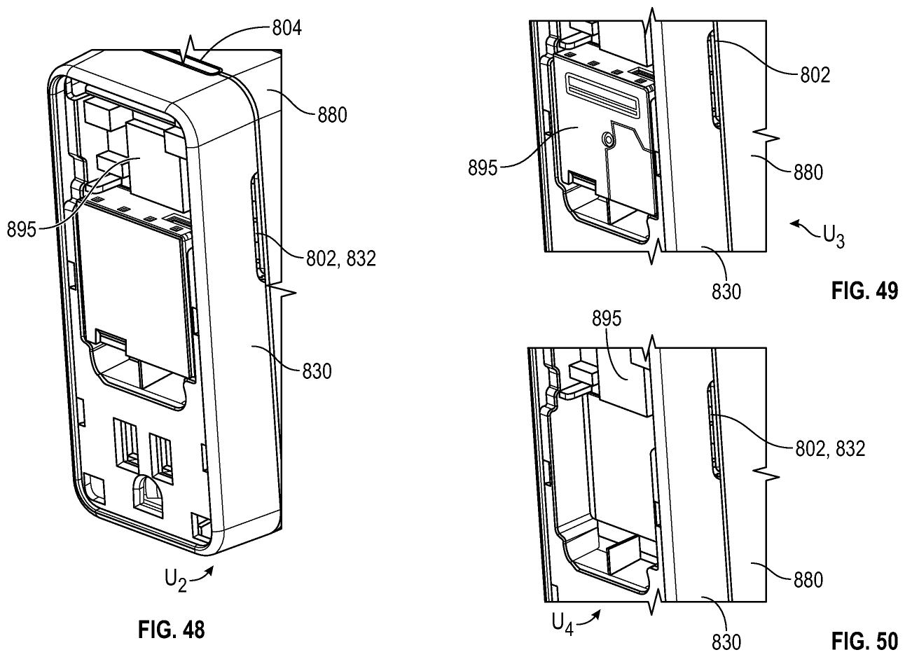

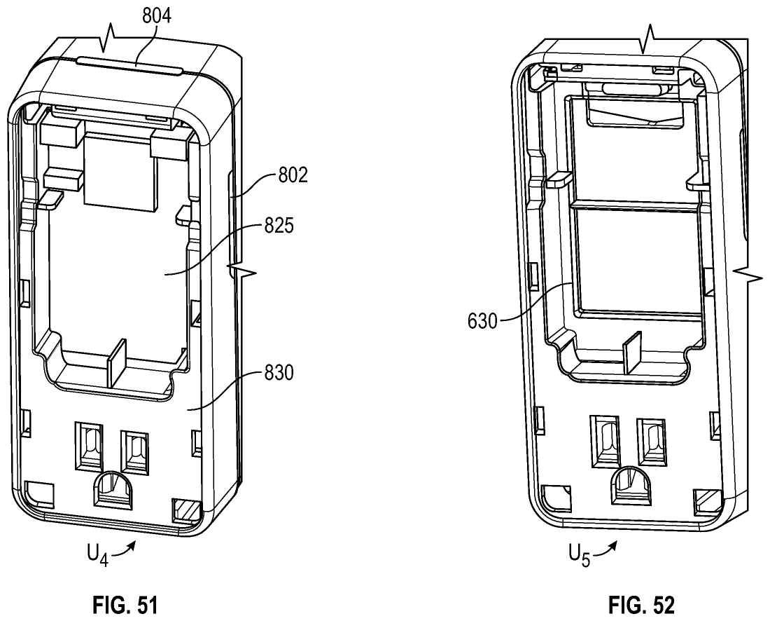

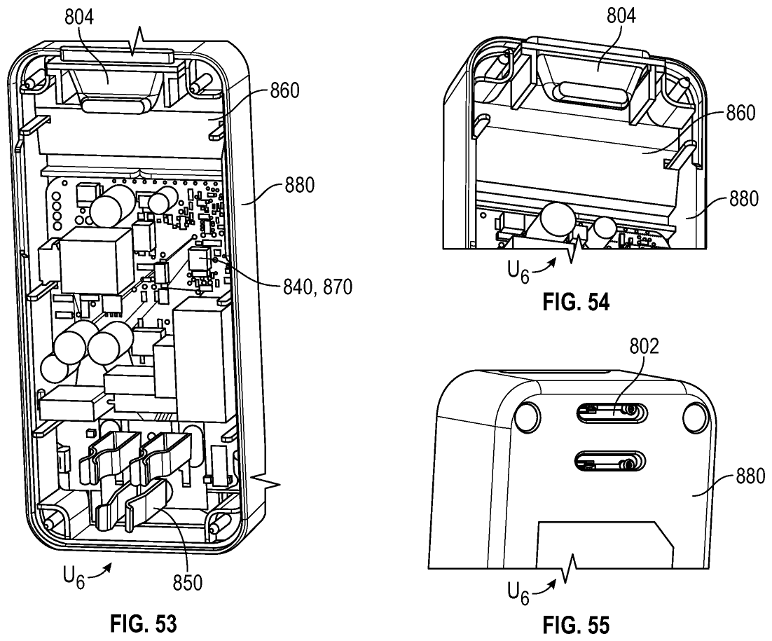

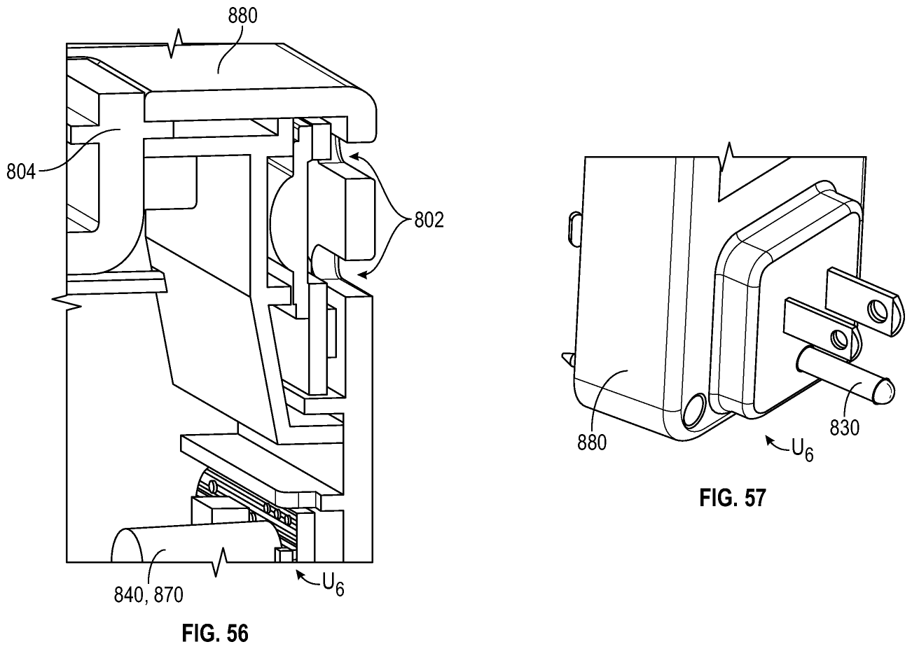

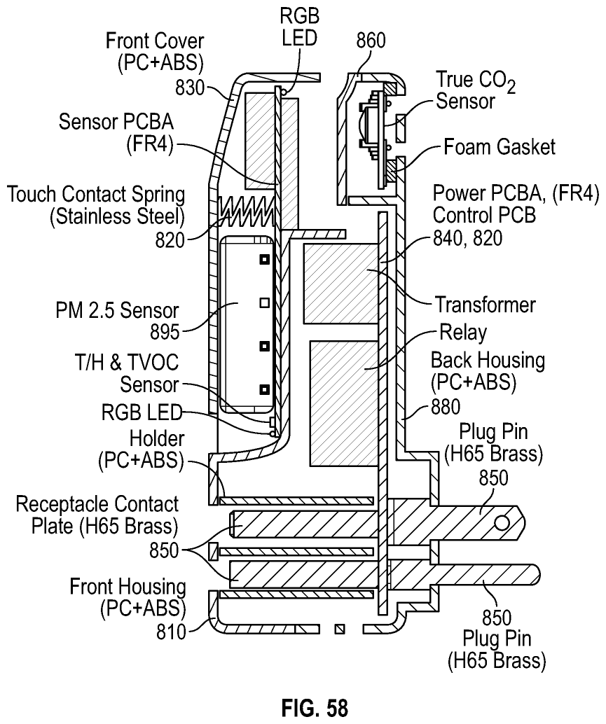

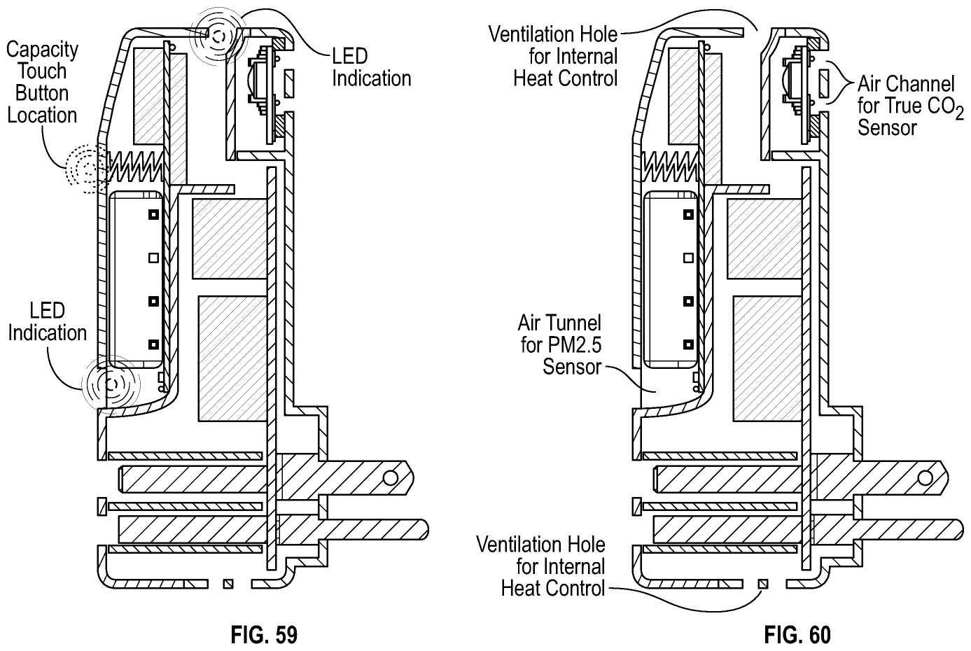

FIGS. 3A-66 show exemplary monitoring devices 102 and their associated circuitry of the IAQ system 10. Specifically, FIGS. 1-29 are directed at a monitoring device 102 that has a light switch configuration 400, FIGS. 30-62 are directed at a monitoring device 102 that has a plug configuration 600. The light switch configuration 400 of the monitoring device 102 includes: (i) buttons and light pipes 410, (ii) housing and antenna 420, (iii) sensor board 430, (iv) bottom housing 440, (v) top cover 450, (vi) power PCB 460, (vii) holder 470, (viii) wiring PCB 480, and (ix) rear cover 490. Additional details about these structures are shown in the various unassembled states along with the cross-sectional view that is shown in FIG. 19. Referring to FIGS. 4, 6, and 7, the bottom housing 440 includes a plurality of openings 442 formed therethrough. These openings 442 serve multiple purposes including letting air flow into the monitoring device 102 and allow light to escape from the monitoring device 102. The light that escapes through these openings 442 acts as a status indicator 216 for the monitoring device 102. Wherein the monitoring devices 102 may show a red light if the air quality is bad, a green light if the air quality if good, and a yellow light if the air quality is between bad and good. This light is emitted by LEDs 347 that coupled to the backlight 435.

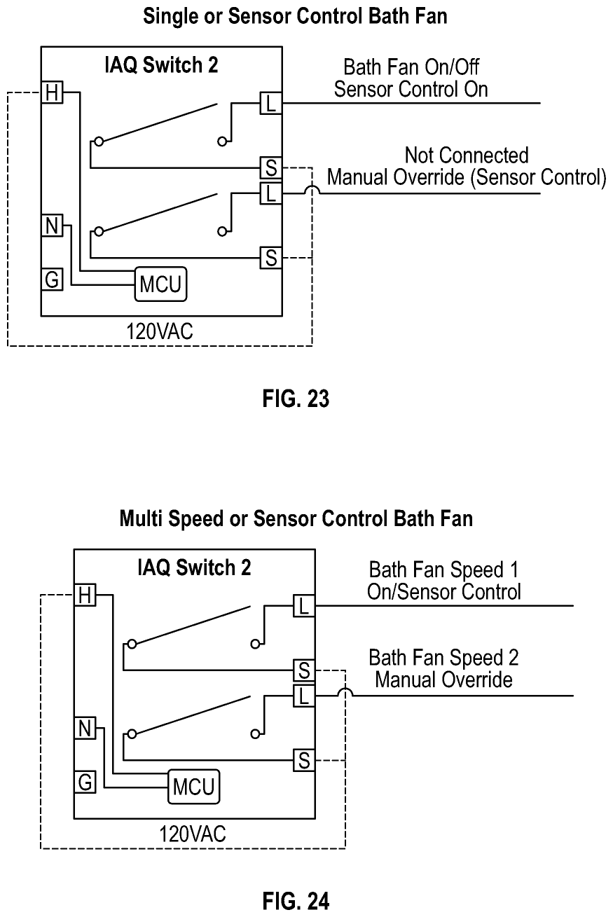

FIGS. 23-29 show various circuit diagrams of the monitoring device 102 that has a light switch configuration 400. Specifically, these circuit diagrams show the buttons 410 that are contained within the light switches 400 are programmable, such that the user can alter what functionality the buttons 410 control. For example, a first light switch 400 may be coupled to a single bath fan that has one speed. In this configuration, the bottom button may allow the user to manually control the bath fan. For example, depressing the button a first time may turn the bath fan on and depressing the button a second time may turn the bath fan off. The top button may allow the user to override or turn off the IAQ system 10. For example, depressing the button a first time may place this appliance 106 of the IAQ system 10 in a do not disturb mode, and depressing the button a second time may remove the appliance 106 from the do not disturb mode. To indicate to the user whether they do not disturb more is one, an indicator may be positioned within the button or adjacent to the button.

FIG. 24 shows how the light switches 400 that is shown in FIG. 23 can be programmed in a different manner to control a multi-speed bathroom fan. In this embodiment, the light switch 400 has been programmed to allow a user to: (i) manually turn the fan on to a first speed by depressing the button a first time, if the system 10 has not determined that the fan needs to be running at a second speed (see flowcharts within PCT/US20/12487) and (ii) manually turn the fan to a second speed by depressing the button a first time. It should be understood depressing the top button will override the system's 10 decision only if that decision is that the fan should be off. In other words, depressing the top button will turn the fan to a first speed only if the system 10 has determined that the fan should be off. Alternatively, depressing the tip button will not override the system's decision if that decision is that the fan should be at a second speed. In other words, if the user depresses the top button while the system 10 has determined that the fan should be a second speed, the system 10 will override the user's selection and will keep the fan at the second speed. Meanwhile, depressing the bottom button will always override the system's 10 decisions and will turn the fan to a second speed. It should be understood that the user may put the multi-speed fan into a do not disturb state by pressing a combination of the buttons (e.g., both the top and bottom together, a press and hold for 3 seconds on the stop button, or another button combination). Because the light switches 400 are programmable, an installer can set up all of these functions within each light switch 400 without needing additional parts or parts that are specifically tailored to each application. This saves time and expense for all parties.

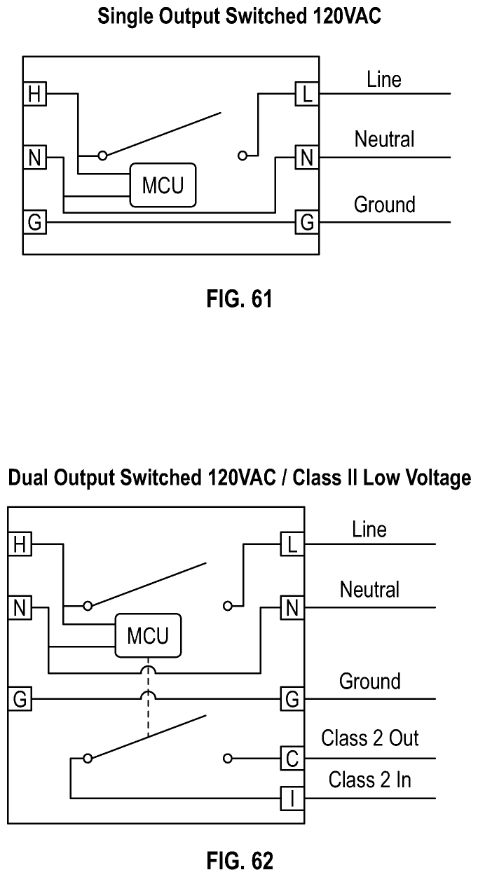

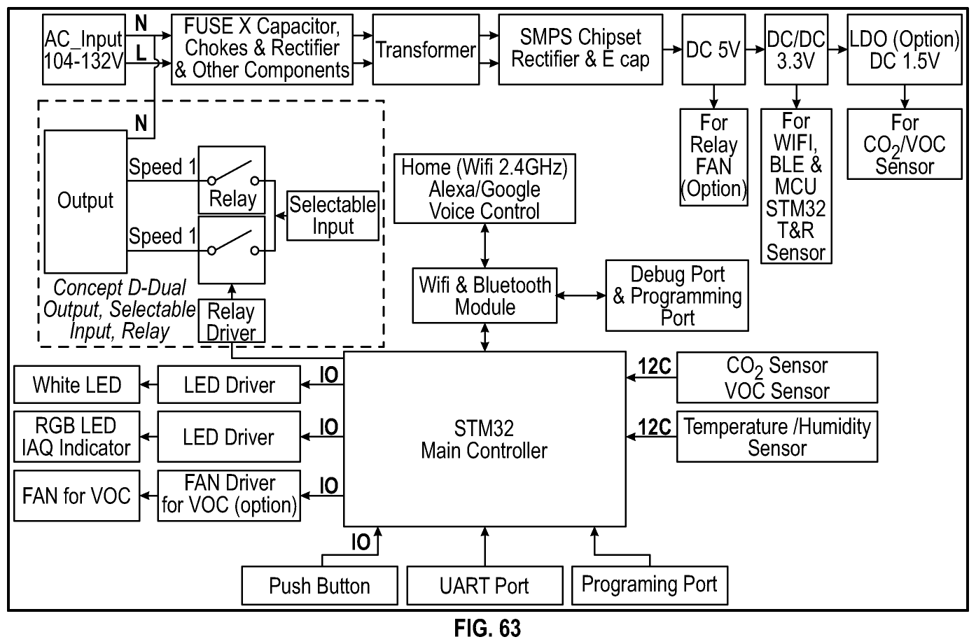

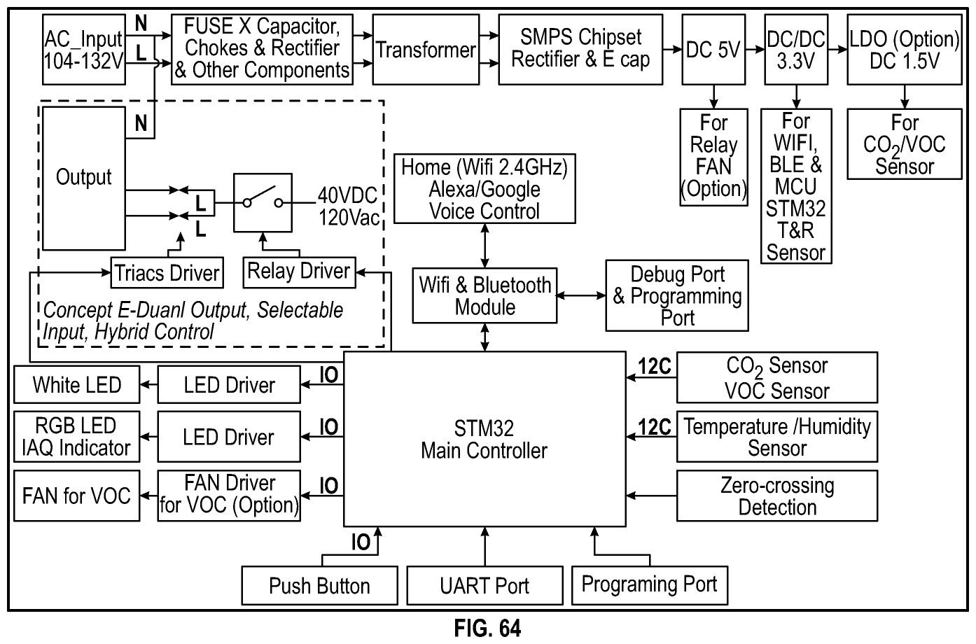

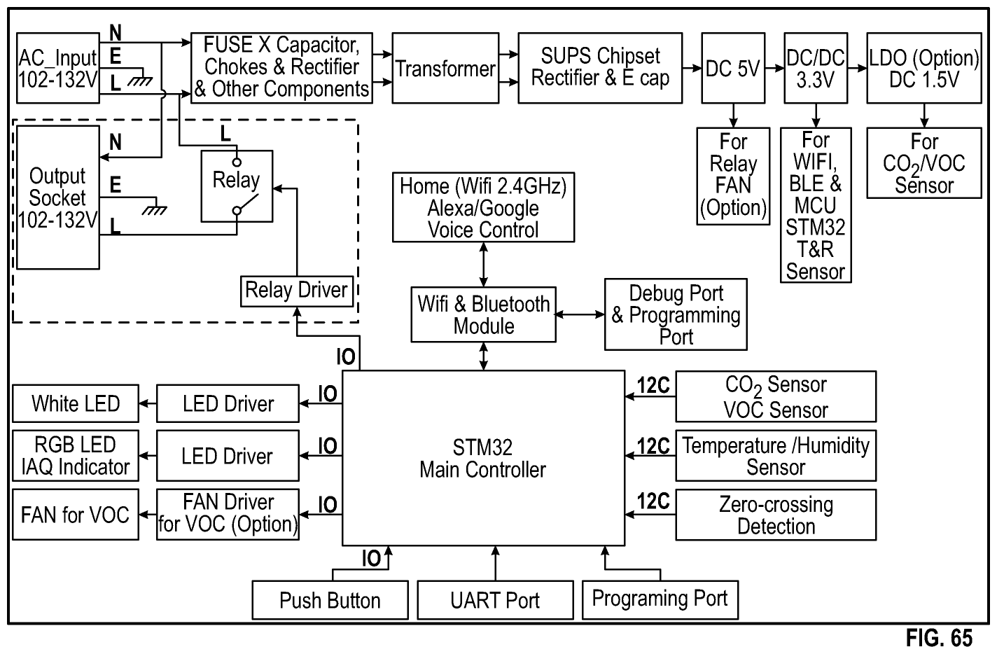

As shown in FIGS. 30A-42, the plug configuration 600 of the controller includes: (i) faceplate 610, (ii) buttons and lightguide 620, (iii) front cover 630, (iv) control PCB 640, (v) terminals 650, (vi) inner holder and antenna 660, (vii) power PCB 670, (viii) back cover 680, and (ix) side cover 490. As described within PCT/US20/12487, the controller is similar to the monitoring device 102 because it can communicate with the IAQ system 10 and be used to control a non-connected appliance 400. However, unlike the monitoring device 102, the controller does not contain sensors or most of the modules contained within the monitoring devices 102. Instead, the controller merely includes a connectivity module 210 and a power control module 206. By only containing these two modules, the controller can be smaller, may be designed to be retrofitted into existing non-connected devices 450, and can be utilized in locations where sensor data is not desired. Like the light switch 400 that is described above, the buttons within this controller can be programmed to allow the user to control how the plug 600 controls the appliance 106 connected thereto. Examples of such configurations are shown in FIGS. 61-62.

As shown in FIGS. 30A-30F and 45-60, the plug configuration 800 of the monitoring device 102 includes: (i) faceplate 810, (ii) buttons and lightguide 820, (iii) front cover 830, (iv) control PCB 840, (v) terminals 850, (vi) inner holder 860, (vii) power PCB 870, (viii) back cover 880, and (ix) sensors 985. Like the monitoring device 102 described above, this monitoring device 102 includes a plurality of air inlets/outlets 802. Specifically, front 812, 184 air inlets/outlets 802 are formed within the faceplate 810 and on the side 832 air inlets/outlets are formed within the side of the monitoring device 800. These air inlets/outlets 802 allow air to flow over the sensors 895 to measure and collect air data. Also, like the above described devices, the plug configuration 800 of the monitoring device 102 can have programmable buttons that allow the user to control how the plug 800 controls the appliance 106 connected thereto. Examples of such configurations are shown in FIGS. 61-62.

4) Industrial Design

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Other implementations are also contemplated.

While some implementations have been illustrated and described, numerous modifications come to mind without significantly departing from the spirit of the disclosure; and the scope of protection is only limited by the scope of the accompanying claims. Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. The indoor air quality (“IAQ”) system, comprising:
a monitoring device that includes: (i) an identity, (ii) a sensor and (iii) a connectivity module, wherein the sensor is configured to record environment data;
a local server/database that includes a connectivity module, wherein the local server/database connectivity module is configured to receive: (i) the monitoring device's identity and (ii) environmental data that has been recorded by the monitoring device;
an appliance that can be selectively controlled by the local server/database; and
wherein the local server/database is configured to: (i) analyze the received environmental data and (ii) selectively control the appliance based on the received environmental data.

2. The IAQ system of claim 1, wherein the monitoring device is not electrically or directly connected to the appliance.

3. The IAQ system of claim 1, wherein the local server/database turn ON the appliance when a level of a component contained within the environmental data is over a predefined threshold value.

4. The IAQ system of claim 1, wherein the predefined threshold value is set by a regulatory body, government agency, private group or standard setting body.

5. The IAQ system of claim 4, wherein the predefined threshold value is set: (i) using the sensor to record environmental data over a predefined amount of time and (ii) adjusting the predefined threshold value in light of the record environmental data.

6. The IAQ system of claim 1, wherein the sensor measures levels of least one of the following: CO, CO2, NO, NO2, NOX, PM2.5, ultrafine particles, radon, volatile organic compounds, ozone, dust particulates, lead particles, acrolein, biological pollutants, pesticides, or formaldehyde.

7. The IAQ system of claim 1, further comprising a plurality of appliances and a plurality of monitoring devices, wherein each monitoring device within the plurality of monitoring devices is assigned to at least one of the appliances within the plurality of appliances.

8. The IAQ system of claim 1, further comprising a plurality of appliances, wherein the local server/database: (i) selects one of the appliances from the plurality of applications that can improve the air quality and (ii) controls the selected application to improve the air quality.

9. The IAQ system of claim 8, wherein controlling the selected appliance includes: (i) turning the selected appliance to a first setting if a level contained within the environmental data is over a first predetermine threshold, (ii) turning the selected appliance to a second setting if the level contained within the environmental data is over a second predetermine threshold, and (ii) turning the selected appliance to a third setting if the level contained within the environmental data is over a third predetermine threshold.

10. The IAQ system of claim 1, further includes an internet enabled device that is configured to display environmental data that has been collected over a predefined amount of time.

11. The IAQ system of claim 1, wherein the appliance is a ventilation device that is affixed to the structure.

12. The IAQ system of claim 11, wherein the ventilation device is one of the following: a range hood, a bathroom fan, or a supply fan.

13. A method for monitoring levels of components in environmental data and operating a monitoring device within a structure, the method comprising:
providing a monitoring device that includes: (i) an identity and (ii) a sensor that records environment data;
receiving, at a local server/database,: (i) the monitoring device's identity and (ii) environmental data that has been recorded by the monitoring device; and
controlling the operation mode of an appliance using the local server/database, wherein the operation mode is selected based on a comparison of the environment data with predetermined threshold values.

14. The method of claim 13, wherein the operation mode of the appliance is not directly determined by the monitoring device.

15. The method of claim 13, wherein the operational mode is set to ON, when a level contained within the environmental data is over a predefined threshold value.

16. The method of claim 15, wherein the predefined threshold value is set by a regulatory body, government agency, private group or standard setting body.

17. The method of claim 13, further comprising the following steps:
receiving a first set of environmental data that includes one level that is above a predefined threshold value;
selecting an appliance out of a plurality of appliances that can bring the level within the environmental data below the predefined threshold value;
sending a signal from the local server/database to turn ON the selected appliance;
receiving a second set of environmental data that includes one level that is below a predefined threshold value;
sending a signal from the local server/database to turn OFF the selected appliance.

18. The method of claim 17, wherein the step of selecting an appliance out of a plurality of appliances that can bring the level of the level within the environmental data below the predefined threshold value includes selecting the appliance that is assigned to the monitoring device.

19. The method of claim 17, wherein the step of selecting an appliance out of a plurality of appliances that can bring the level within the environmental data below the predefined threshold value includes selecting the appliance that can bring the level within the environmental data below the predefined threshold value in the shortest amount of time.

20. The method of claim 13, further comprising the step of displaying the recorded environmental data on an internet enabled device.

21. A method for monitoring levels of components in environmental data and operating an appliance within a structure, the method comprising:
providing an appliance with at least one sensor; monitoring levels of components in environmental data using the at least one sensor;
determining that a level is above a predefined threshold range for that component;
analyzing data from other sensors to determine if said sensors measured the level above a predefined threshold range;
generating a plan designed to return the level of the component within the predefined threshold range;
informing the user of the generate plan; and
performing the generated plan.

22. The method of claim 21, wherein the step of performing the generated plan includes: (i) instructing an appliance to turn ON and (ii) instructing the appliance to turn OFF, when the level is within the predefined threshold range.

23. An indoor air quality (“IAQ”) system, as shown and disclosed herein.

24. An indoor air quality (“IAQ”) system, as shown and disclosed in FIGS. 1-66.

25. A method for monitoring levels of components in environmental data and operating a monitoring device within a structure, as shown and disclosed herein.

26. A method for monitoring levels of components in environmental data and operating a monitoring device within a structure, as shown and disclosed in FIGS. 1-66.

27. A method for monitoring levels of components in environmental data and operating an appliance within a structure, as shown and disclosed herein.

28. A method for monitoring levels of components in environmental data and operating an appliance within a structure, as shown and disclosed in FIGS. 1-66.
